(19) United States
(12) Patent Application Publication
(10) Pub. No.: US 2026/0338593 A1
(43) Pub. Date: Oct. 29, 2026

(54) WEIGHING SYSTEM AND METHOD FOR LABORATORY CAGES

(71) Applicant: TECNIPLAST S.P.A., Buguggiate (IT)

(72) Inventors: Pietro BERNARDINI, Casciago (IT); Marco GARZOLA, Varese (IT); Vincenzo CAROLLO, Varese (IT); Niccolò GUMIERO, Gallarate (IT); Giorgio ROSATI, Milano (IT); Marco STORTO, Monza (IT)

(21) Appl. No.: 18/998,985

(22) PCT Filed: Jul. 27, 2023
(86) PCT No.: PCT/IB2023/057617

§ 371 Date: Jan. 27, 2025

(30) Foreign Application Priority Data
Jul. 28, 2022 (IT) 102022000016005

(51) Int. Cl. G01G 19/52; A01K 1/03; G01G 21/28; G01G 23/18

(52) U.S. Cl. CPC G01G 19/52; A01K 1/0317; G01G 21/28; G01G 23/18

(57) ABSTRACT

Weighing system suitable to be applied to a laboratory cage comprising a container (1) having an opening which can be closed by a lid (2), wherein the weighing system comprises a central unit (21) and one or more weighing modules (22) suitable to be mechanically connected to a suspended module (24, 25, 26, 27, 29) which can support or contain a mass to be weighed in the laboratory cage, wherein the central unit (21) and the weighing modules (22) are applied to a partition (23; 28) suitable to be arranged with the central unit (21) and the weighing modules (22) inside the laboratory cage with the container (1) closed by the lid (2). The present description also relates to a weighing method which can be implemented by said system and a laboratory cage comprising said system.

### TECHNICAL FIELD

The present description relates to a weighing system for laboratory cages, in particular a system which can be used to weigh food, drinks and/or animals contained in a laboratory cage. The present description also relates to a weighing method which can be implemented by said system and a laboratory cage comprising said system.

### BACKGROUND OF THE DESCRIPTION

WO 2014/118727 A1 discloses a known type of shelf and laboratory cage, wherein the laboratory cage can contain one or more animals for scientific experiments. During these experiments, an operator can periodically extract a cage from the shelf on which various cages are placed, in order to manually and individually weigh the food, water and animal contained in the cage by means of a precision electronic scale positioned on the worktop of the operator, after which he puts everything back in the cage and puts the cage back on the shelf.

This weighing method has at least two problems. The first problem is the disturbance of the animal due to the extraction of the cage from the shelf and its handling, which generally takes place during the day, namely during the animal's rest period, with consequent stress induced in the animal and therefore the risk of influencing the results of the experiment.

The second problem is the low reliability of a daily weighing, which does not consider variations in weight and consumption of water and food during the day. More detailed information of the metabolism of the animal and therefore a higher quality of the results of the experiment can be obtained not only by weighing how much food has been eaten or how much water has been drunk in a day but also the moments of the day in which this occurs, together to the weight of the animal during these moments.

To solve these problems, the weighing systems PhenoMaster of TSE Systems and Promethion of Sable Systems include weigh modules that can be attached to the lid of a laboratory cage, outside of this cage, to weigh continuously and directly a feeder with food, a drinker with water and a shelter for the animal arranged inside the cage.

However, these known weighing systems are relatively bulky, since the weighing modules protrude outside the cage and are connected with cables to external devices for powering the weighing modules and for collecting the signals transmitted by the weighing modules. Therefore, the cage cannot be inserted into the shelf in which it was inserted without the weighing system, since it is bulkier, so as to require dedicated shelves with fewer workstations or additional space in the laboratory.

Furthermore, the cage with one of said known weighing systems cannot be connected to standard ventilation devices, so as to limit the times, quantities and/or modalities of the possible experiments, in particular experiments on several cages in parallel, with consequent longer times and higher costs. Furthermore, the lack of ventilation reduces the time spent by the animal in the cage, since a correct recirculation of air and harmful substances such as ammonia and carbon dioxide cannot be guaranteed, also exposing the operator to potential infectious and allergenic agents. A further problem of said known weighing systems is that the weighing modules hooked to the lid of the cage are relatively complex devices which require the lid to be opened for a relatively long time when they have to be applied to or removed from the lid, with the risk that the animal escapes from the cage. Furthermore, the feeder of these known systems is relatively unreliable, since the food that falls is collected by a shelf arranged underneath it, so that it does not guarantee that it remains inside the feeder, thus altering the weighing phases and collecting foreign substances such as litter and paper carried by the animal.

US 2017/0105385 A1 discloses a system according to the preamble of claim 1. US 2019/014741 A1, US 2018/007862 A1 and CN 11156748 A disclose similar systems.

### SUMMARY OF THE DESCRIPTION

Object of the present description is therefore to provide a system which solves these problems. Said object is achieved with a system, a method and a cage, the main features of which are specified in the attached claims, to be considered an integral part of the present description.

Thanks to its particular structure, the system according to the present description allows the automatic and continuous weighing of food, water and animals and can in any case be applied inside a cage of the known type, which can therefore be inserted without particular modifications with the system in its shelf, such as for example the cage and shelf described in WO 2014/118727 A1.

The system preferably comprises an autonomous central unit which is powered by batteries and/or communicates with the outside with a wireless communication.

The central unit preferably comprises a control device which communicates with the weighing modules, collects their data, stores them, processes them and/or transmits them to an external processor. The central unit preferably comprises a display for displaying system information and/or a power unit controlled by the control device.

The central unit preferably comprises one or more antennas which are arranged on printed circuit boards and/or in a separate location within the cage, and/or comprise the same partition which supports the central unit, if made of metal, in order to improve the quality of data transmission and/or reduce electricity consumption.

The system preferably comprises one or more weighing modules separated from the central unit, so as to improve the ventilation in the cage and more easily manage the arrangement of the weighing modules on the partition, with consequent advantages in the use and adaptation of the cage to the requirements of the experiment in which the cage is being used.

The weighing modules include a particular screw mechanism which facilitates the mechanical connection with the modules suspended in the cage, such as for example a feeder, a drinker, a wheel and/or shelters for the animal.

Thanks to the particular reciprocal arrangement of the partition, central unit and weighing modules, the system allows adequate ventilation of the cage, which, with fluid dynamics simulations, resulted substantially equal if not even better than the ventilation of the same cage without the system but with a traditional feeder.

The particular partition allows not only to adequately support the central unit and the weighing modules but also to protect them from the animal contained in the cage without compromising the functions of the suspended modules.

The particular structure of the system also allows its application in an easy, fast and stable way to a cage, even of a known type, in order to simplify the preparation of the cage and limit vibrations that could affect the reading of the weighing, also guaranteeing the closure of the cage with its standard lid, which only needs to be lifted for the short time necessary to insert the system into the cage.

The partition is preferably provided with particular vents which guarantee the continuity of the air flows and their optimal distribution in the cage, adapting them to the arrangement and shape of the suspended modules used in the system.

A feeder provided with a particular container with grid can be applied to the system according to the present description and is more reliable than the known feeder, as it does not collect foreign substances and the food does not fall outside the container, so as to improve the accuracy of the data of weighing.

In the system and method according to the present description, the data coming from the weighing modules are collected periodically by the central unit, stored in a memory and transmitted to an external processor at programmable time intervals according to the needs of the experiment to be performed in the laboratory, so as to save additional electricity.

Since the system and the method can be used with known types of cages and shelves, the laboratory animals are not subjected to stress due to the change of environment, so as to improve the results of the experiments. Thus, experiments can be performed without acclimation time of the animals in a new environment. Furthermore, the time spent by the animal in the cage should not be limited, thanks to the ventilation of the cage made possible by the architecture of the system.

The use of cages and shelves of the known type also makes it possible to optimize costs and space in the laboratory, offering high scalability in the arrangement of the cages according to the dimensions of the laboratory.

The particular weighing module allows for easy installation in the system and quick and easy connection with various types of suspended modules. Furthermore, the structure and architecture of the weighing module allow for high accuracy in weighing readings, reducing sources of noise, such as vibrations or accidental movements. For this purpose, the weighing module can comprise a particular load cell which is fixed in a stable manner directly to the partition.

In particular, the central unit and the weighing modules are inserted in one or more enclosures which are preferably separated from each other to improve ventilation and/or are watertight, so as to protect the mechanical, electrical and/or electronic components from dirt, and above all to disinfect the central unit and the weighing modules with standard disinfectants.

The weighing module preferably comprises one or more particular sensors for detecting the vibrations generated by the interaction of the animal with the suspended module connected to the weighing module, so as to awaken the central unit for the weighing phase only when the animal eats, drinks, runs, enters or leaves a shelter. This optimizes electricity consumption.

The central unit preferably comprises an RFID reader for reading the RFID tag containing the cage identification code, so as to associate the weighing data with the cage. The central unit may also include its own RFID tag which may replace the RFID tag of the cage or even be added to it to identify the central unit. Thanks to this arrangement, the operator no longer has to concern himself with guaranteeing the traceability of the cage but can insert it in any position of the shelf, as the system and the method, through their communication architecture, automatically guarantee the tracking of the cage and the correspondence between the weighing data and the cage, wherever it is on the shelf.

When the central unit is equipped with its own RFID tag, the latter can also be used to transmit data from the control device of the central unit to the outside, such as weighing data, possible system alarms, battery level status and other system information. This data written in the RFID tag of the system can be read by the RFID readers arranged in the shelf, so as to simplify the system and the communication of weighing data. Furthermore, the RFID tag of the central unit can also receive data transmitted by an external RFID transmitter and send it to the control device, for example to trigger the transmission of data stored in the central unit via a Wi-Fi transceiver.

Therefore, the radio communication enabling of a plurality of weighing systems can be managed centrally by an external computer to ensure that there are no multiple parallel communications which risk disturbing or even causing the radio communication signals to be lost.

The RFID tag of the central unit can be associated with the cage by an operator when the system is applied to the cage, thus not requiring the RFID tag in the lid. If instead the central unit includes the RFID antenna, the association between the cage and the central unit is automatic.

### BRIEF DESCRIPTION OF THE DRAWINGS

Further advantages and features of the system, method and cage according to the present description will become apparent to those skilled in the art from the following detailed description of some embodiments thereof, to be considered non-limiting examples of the claims, with reference to the accompanying drawings in which:

FIG. 1 shows an axonometric view of a first embodiment of a cage comprising the system;

FIG. 2 shows the cage of FIG. 1 without the lid;

FIG. 3 shows a top view of the cage of FIG. 1;

FIG. 4 shows the section A-A of FIG. 3;

FIG. 5 shows the section B-B of FIG. 3;

FIG. 6 shows the section C-C of FIG. 3;

FIG. 7 shows a side view of the cage of FIG. 1;

FIG. 8 shows an exploded view of the cage of FIG. 1;

FIG. 9 shows an axonometric view of the partition of the cage of FIG. 1;

FIG. 10 shows a top view of the partition of FIG. 9;

FIG. 11 shows a side view of the partition of FIG. 9;

FIG. 12 shows a front view of the partition of FIG. 9;

FIG. 13 shows a first axonometric view of the central unit of the cage of FIG. 1;

FIG. 14 shows a second axonometric view of the central unit of FIG. 13;

FIG. 15 shows a front view of the central unit of FIG. 13;

FIG. 16 shows the section A-A of FIG. 15;

FIG. 17 shows a top view of the central unit of FIG. 13;

FIG. 18 shows the section B-B of FIG. 17;

FIG. 19 shows an exploded view of the central unit of FIG. 13;

FIG. 20 shows a side view of a weighing module of the cage of FIG. 1;

FIG. 21 shows a bottom view of the weighing module of FIG. 20;

FIG. 22 shows a front view of the weighing module of FIG. 20;

FIG. 23 shows a top view of the weighing module of FIG. 20;

FIG. 24 shows the section A-A of FIG. 23;

FIG. 25 shows the section B-B of FIG. 24;

FIG. 26 shows a first exploded view of the weighing module of FIG. 20;

FIG. 27 shows a second exploded view of the weighing module of FIG. 20 with the feeder of the cage of FIG. 1;

FIG. 28 shows an exploded view of the feeder of FIG. 27;

FIG. 29 shows a side view of the feeder of FIG. 27;

FIG. 30 shows a top view of the feeder of FIG. 27;

FIG. 31 shows a front view of the feeder of FIG. 27;

FIG. 32 shows a top view of the weighing unit of FIG. 20 with the wheel of the cage FIG. 1;

FIG. 33 shows the section AA of FIG. 32;

FIG. 34 shows a front view of the wheel of FIG. 32;

FIG. 35 shows a rear view of the wheel of FIG. 32;

FIG. 36 shows a top view of the weighing module of FIG. 20 with a first shelter for the cage of FIG. 1;

FIG. 37 shows the section A-A of FIG. 36;

FIG. 38 shows a front view of the shelter of FIG. 36;

FIG. 39 shows a rear view of the shelter of FIG. 36;

FIG. 40 shows a top view of the weighing module of FIG. 20 with a second shelter for the cage of FIG. 1;

FIG. 41 shows a side view of the shelter of FIG. 40;

FIG. 42 shows a front view of the shelter of FIG. 40;

FIG. 43 shows a rear view of the shelter of FIG. 40;

FIG. 44 shows an axonometric view of a second embodiment of a cage comprising the system;

FIG. 45 shows the cage of FIG. 44 without the lid;

FIG. 46 shows a top view of the cage of FIG. 44;

FIG. 47 shows the section A-A of FIG. 46;

FIG. 48 shows the section B-B of FIG. 46;

FIG. 49 shows the section C-C of FIG. 46;

FIG. 50 shows a side view of the cage of FIG. 44;

FIG. 51 shows an exploded view of the cage of FIG. 44;

FIG. 52 shows a top view of the weighing module of FIG. 20 with the drinker for the cage of FIG. 1;

FIG. 53 shows the section A-A of FIG. 52;

FIG. 54 shows a front view of the drinker of FIG. 52;

FIG. 55 shows a rear view of the drinker of FIG. 52;

FIG. 56 shows an axonometric view of the partition of the cage of FIG. 44;

FIG. 57 shows a top view of the partition of FIG. 56;

FIG. 58 shows a side view of the partition of FIG. 56;

FIG. 59 shows a front view of the partition of FIG. 56;

FIG. 60 shows a top view of the first printed circuit board of the central unit of FIG. 13;

FIG. 61 shows a top view of the second printed circuit board of the central unit of FIG. 13;

FIG. 62 shows a side view of the printed circuit board of the weighing module of FIG. 20;

FIG. 63 shows a block diagram of the central unit of FIG. 13 and of the weighing module of FIG. 20;

FIG. 64 shows a block diagram of the adapter circuit of the weighing module of FIG. 20;

FIG. 65 shows a front view of a shelf with the cage of FIG. 1;

FIG. 66 shows the enlarged detail A of FIG. 65;

FIG. 67 shows an axonometric view of a third embodiment of a cage comprising the system;

FIGS. 68-70 show the results of fluid dynamics simulations performed on a known cage and on the cage of FIG. 1.

### EXEMPLARY EMBODIMENTS

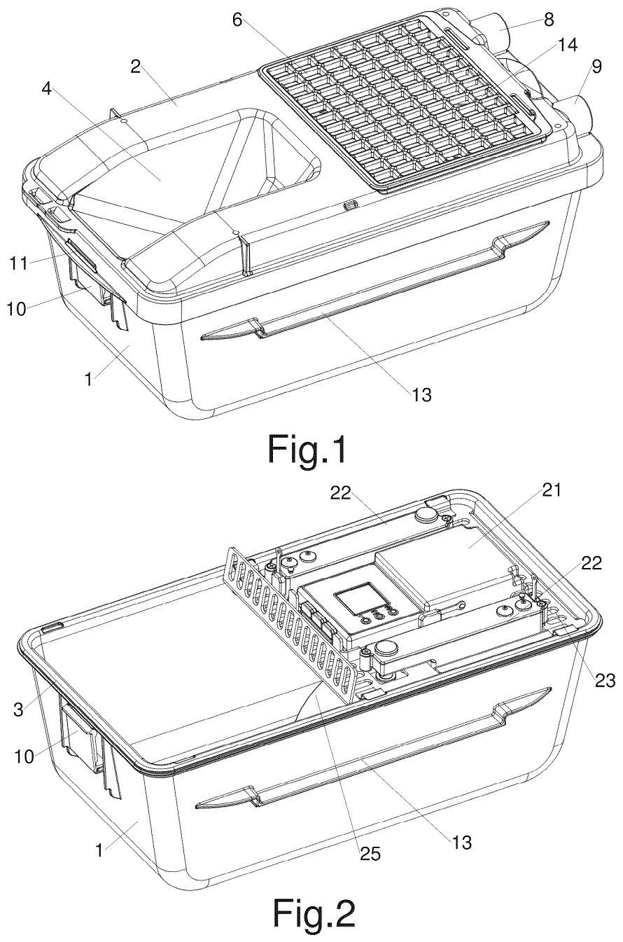

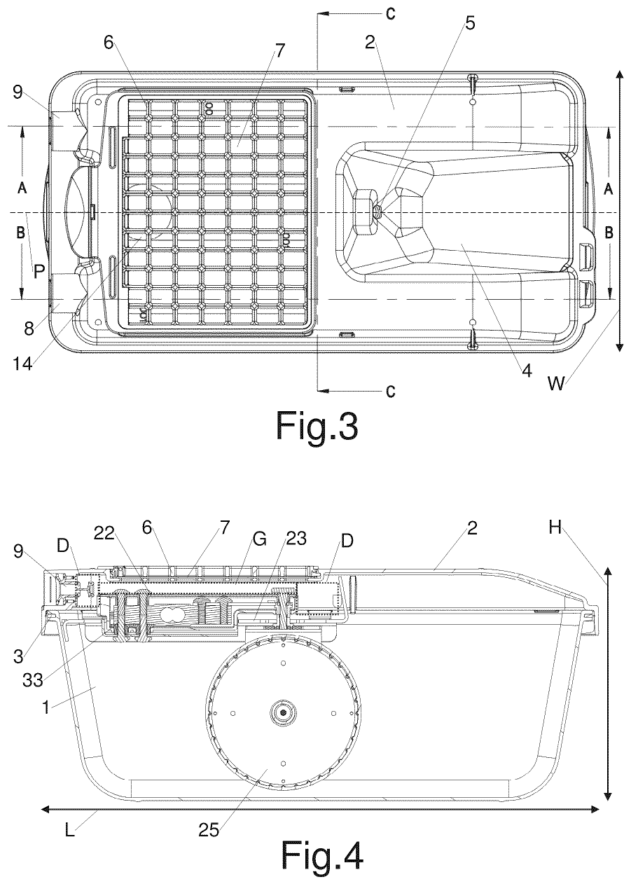

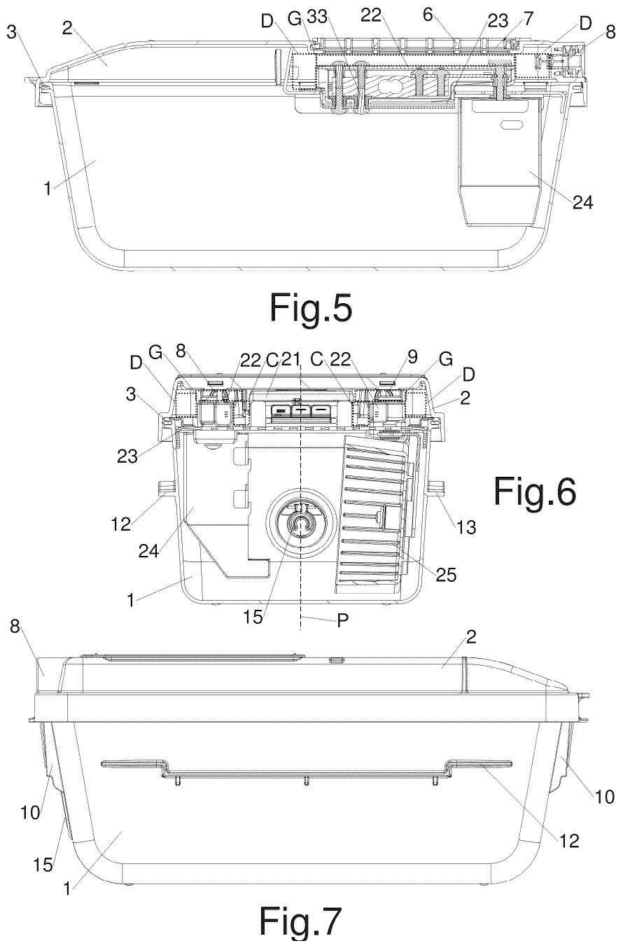

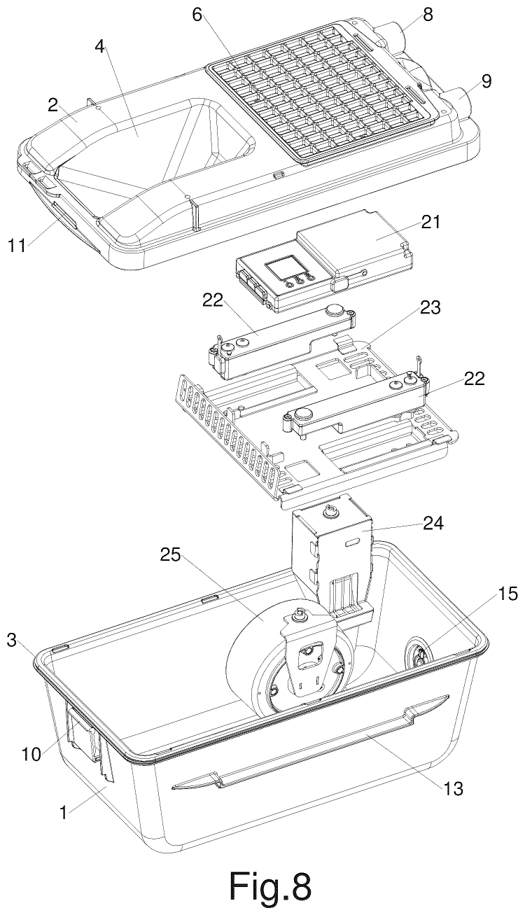

FIGS. 1 to 8 show a first embodiment of a laboratory cage, which comprises a container 1 having an opening, in particular an upper opening with a substantially rectangular shape, which can be closed by a lid 2, in particular having an upper wall joined to one or more side walls which delimit a lower edge of the lid 2. A gasket 3 can be arranged around the upper edge of the container 1 or in the lower edge of the lid 2 to hermetically close the gap between the container 1 and the lid 2. The lower edge of the lid 2 is arranged at a lower level than the edge of the container 1 when the cage is closed. The upper wall of the lid 2 can comprise a seat 4 for housing a drinker (not shown in the figures), a valve 5 for inserting a drinker spout into the cage and/or a grid 6 provided with an air filter 7 for the cage ventilation. A wall of the lid 2, in particular a rear wall, can comprise an inlet duct 8 and/or an outlet duct 9 for the ventilation of the cage. Preferably, the inlet duct 8 and the outlet duct 9 are parallel to each other. The container 1 can comprise stops 10 suitable to be inserted in corresponding cavities 11 of the lid 2, or vice versa, to block the lid 2 on the container 1 when the cage is closed. The container 1 can also comprise lateral guides 12, 13 for suspending the cage on supports of a shelf for laboratory cages. The cage can be provided with its own identification code, in particular contained in an RFID tag 14 which is preferably arranged in the grid 6 of the lid 2, so that the cage can be identified when it is inserted in a shelf comprising a plurality of stations which are equipped with RFID readers, as described in document WO 2014/118727 A1. The container 1 can comprise a valve 15, in particular arranged on a rear wall of the container 1, which is suitable to be coupled with an external conduit to introduce liquids into the container 1, for example water to quench the thirst of the animal in the cage.

Preferably, the container 1 and/or the lid 2 have a substantially truncated pyramid shape (inverted for the container 1), in particular with rounded edges and corners, and/or are made of transparent plastic.

The weighing system of the present description comprises a central unit 21 and one or more weighing modules 22, in particular two weighing modules 22, which are applied, preferably in a removable manner, to a partition 23 suitable to be arranged inside of the cage. The partition 23 can divide the space in which the central unit 21 and the weighing modules 22 are arranged, in particular a space in the lid 2, from the space in which the laboratory animal moves in the cage. The central unit 21 is suitable to receive weighing data from the weighing modules 22, to memorize and/or process the received data and to transmit these processed data outside the cage, preferably by wireless communication. The central unit 21 and the weighing modules 22 are preferably arranged in a portion of the space delimited by the container 1 and in a portion of the space delimited by the lid 2, in particular between the edges of the container and the lid 2.

Preferably, the cage height H is 13-15 cm, the cage length L is greater than twice the height H, for example 30-35 cm, and/or the cage width W is greater than the height H, for example 16-18 cm. The height of the container 1 is 10-12 cm and/or the height of the lid 2 is 3-5 cm. The height of the central unit 21 and/or of the weighing modules 22 is 2-4 cm. The length of the central unit 21 and/or of the weighing modules 22 is 8-12 cm.

Preferably, the central unit 21 and/or the weighing modules 22 have an elongated shape which develops along a longitudinal axis parallel to a median plane of the container 1, of the lid 2 and/or of the partition 23, in particular the median plane P of the partition 23.

The central unit 21 and the weighing modules 22 can be included in a single casing or be arranged in several separate casings. Preferably, the central unit 21 and the weighing modules 22 are separated from each other and arranged on the partition 23 side by side, so that the space between the central unit 21 and a weighing module 22 forms a channel C (shown with dotted lines) which develops along a longitudinal axis parallel to the median plane P. When the cage is closed by the lid 2, the central unit 21 and/or the weighing modules 22 are preferably spaced from the inner surface of the upper wall of the lid 2, so that the inlet duct 8 and/or the outlet duct 9 of the lid 2 open into one or more gaps G (shown with dashed lines) between the lid 2 and the central unit 21 and/or the weighing modules 22. The central unit 21 and/or the weighing modules 22 are preferably spaced apart from the edges of the partition 23, so as to form around the central unit 21 and/or the weighing modules 22 between the lid 2 and the partition 23 one or more passages D (shown with dashed lines) for the circulation of the air coming from the inlet duct 8 and/or leaving from the outlet duct 9. The channels C, the gaps G and/or the passages D are preferably connected to each other so as to form air paths on the partition 23 around the central unit 21 and/or the weighing modules 22.

The weighing modules 22 can be mechanically connected, preferably by a screw fastening device, to one or more suspended modules which can support or contain a mass to be weighed by means of a weighing module 22. The suspended modules can comprise for example a feeder 24 which can contain food for the animal in the cage or a wheel 25 which can contain the animal to be rotated by the latter.

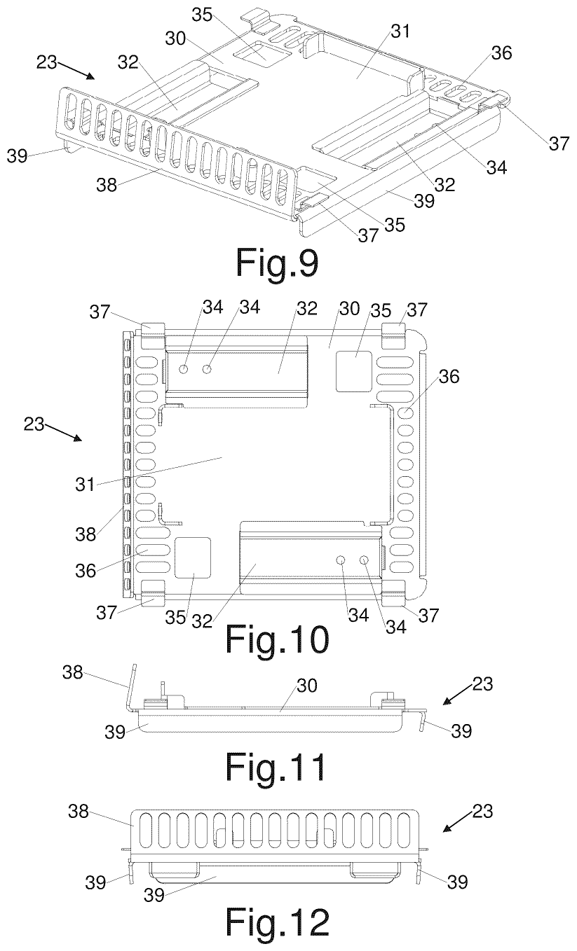

With reference also to FIGS. 9-12, the partition 23 can comprise a plate 30 which is provided with one or more seats 31, 32 to partially or completely house the central unit 21 and/or the weighing modules 22. In particular, the central unit 21 is inserted in its seat 31 without being fixed to the plate 30, while a weighing module 22 is preferably fixed in its seat 32 by one or more screws, in particular two screws 33, each of which passes through a hole in the weighing module 22 and a hole 34 in the plate 30. The plate 30 can comprise one or more windows 35 for the mechanical connection between a weighing module 22 and a suspended module, for example the feeder 24 or the wheel 25. The partition 23 can also comprise one or more vents 36 and/or one or more lateral supports 37, in particular flaps which protrude from the edges of the partition 23, to rest the partition 23 on one or more edges of the container 1, so that the partition 23 partially or completely covers the opening of the container 1 and is blocked by the lid 2 when the cage is closed. The vents 36 are preferably arranged beside the seats 31 and/or 32 of the plate 30, so that the vents 36 open onto one or more channels C and/or passages D arranged around the central unit 21 and/or the modules weighing plate 22. In particular, the vents 36 are arranged one after the other along one or more axes parallel and/or perpendicular to the median plane P of the partition 23. The plate 30 can comprise a grid 38 which projects upwards, namely towards the lid 2, so that the grid 38 divides the space contained in the lid 2 into two parts. The plate 30 can comprise one or more side walls 39 which protrude downwards, namely towards the container 1, to improve stability of the partition 23 when it is placed in the container 1.

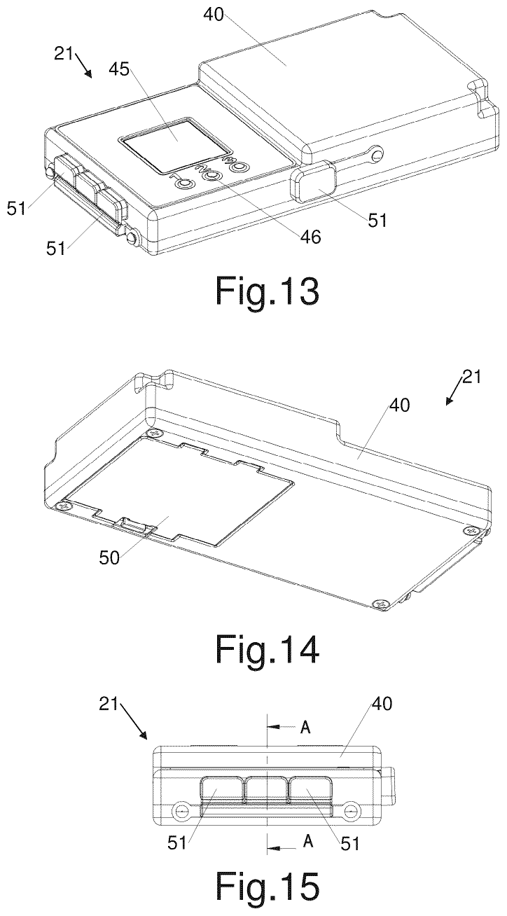

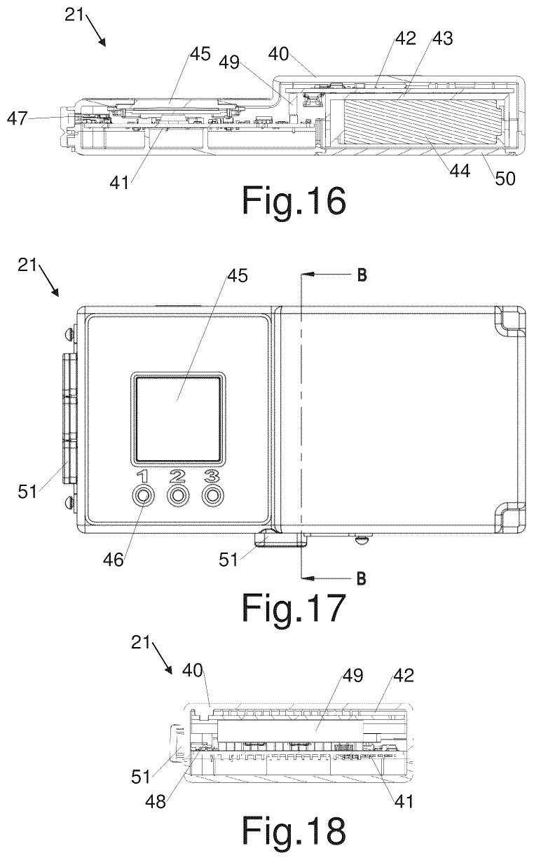

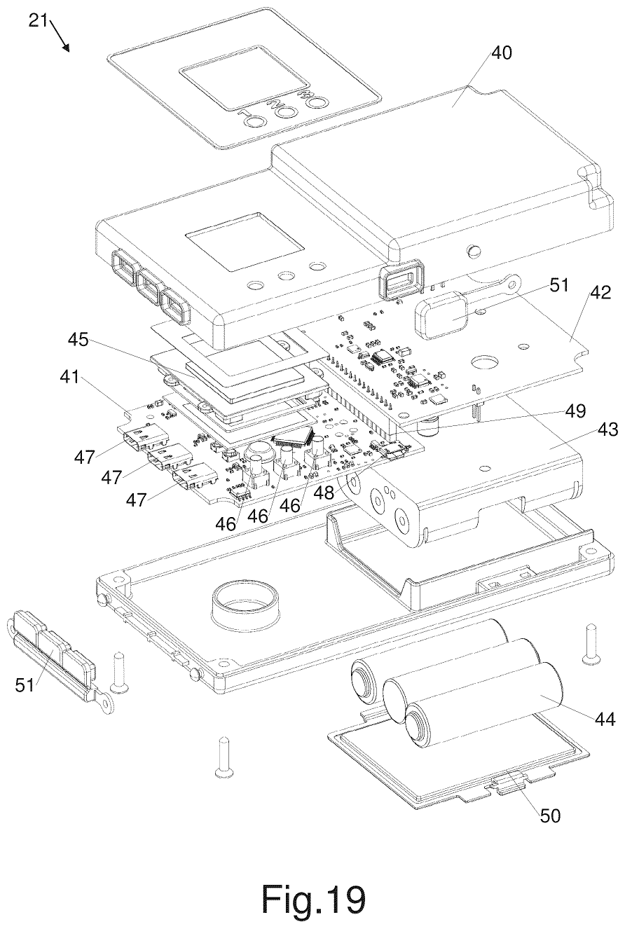

With reference also to FIGS. 13-19, the central unit 21 can comprise a casing 40, preferably watertight, in particular with a degree of protection which is at least IP43, which contains one or more printed circuit boards 41, 42 on which electrical and electronic components are mounted for processing the weighing data transmitted by the weighing modules 22. The casing 40 can also contain a power supply unit 43, preferably a power supply unit with one or more batteries 44, and/or output means 45, preferably an e-ink display, and/or input means 46, preferably one or more buttons, and/or one or more connectors 47, 48, preferably USB connectors, for the electrical connection via cables (not shown in the figures) of the central unit 21 with the weighing modules 22 and/or with external devices for power supply or data transmission. The output means 45, the input means 46 and/or the connectors 47, 48 are preferably mounted on the same printed circuit board 41. In particular, the casing 40 contains two printed circuit boards 41, 42 which are connected together by a connector 49 and are arranged staggered and on two parallel planes, with the power supply unit 43 being arranged beside the first printed circuit board 41 and below the second printed circuit board 42. The casing 40 has a substantially parallelepiped shape, with a higher portion where the second printed circuit board 42 and the power supply unit 43 are arranged. The casing 40 can comprise a door 50 for accessing the power supply unit 43. The connectors 47, 48 are preferably protected by removable caps 51 applied to the casing 40 when connectors 47, 48 are not connected to cables.

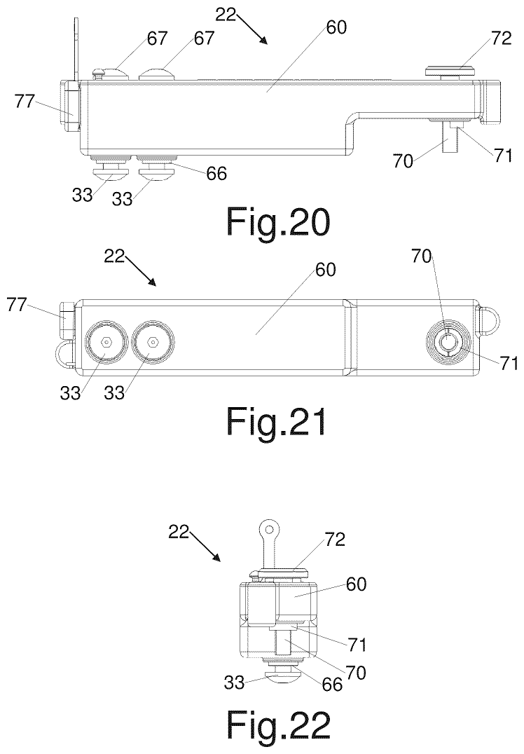

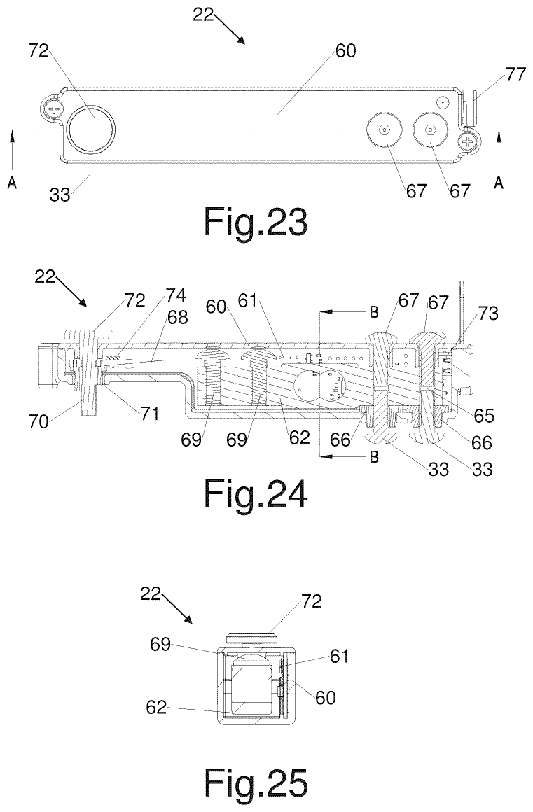

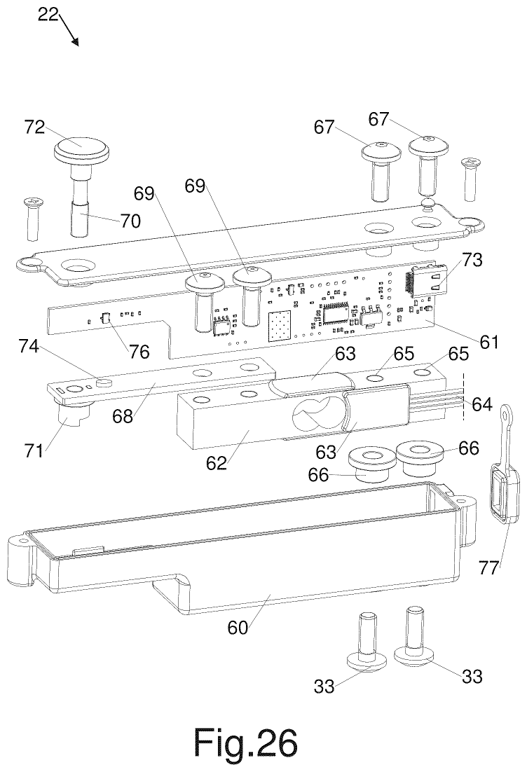

With reference also to FIGS. 20-26, a weighing module 22 can comprise a casing 60, preferably watertight, which contains a printed circuit board 61 on which electrical and electronic components are mounted for acquiring the weighing data, as well as a load cell 62 provided with one or more strain gauges 63 connected to the printed circuit board 61 by means of a cable 64. Preferably, the load cell 62 is arranged beside the printed circuit board 61 and/or is provided with one or more threaded holes 65 for the screws 33 which serve to fix the weighing module 22 to the partition 23 through the holes 34, so that the load cell 62 can be fixed directly to the partition 23. Flanged bushings 66 can be arranged in holes formed under the watertight casing 60 to be crossed by the screws 33. Further screws 67 can be screwed into the threaded holes 65 of the load cell 62 to fix the casing 60 to the load cell 62. An arm 68 is fixed to the load cell 62, in particular by means of screws 69 screwed in threaded holes formed in the load cell 62 on the side opposite the threaded holes 65 for the screws 33, and comprises a device suitable for mechanically connecting a suspended module to the weighing module 22. Said mechanical connection device is preferably a screw fixing device, in particular comprising a screw 70 which can rotate freely in a first shaped bushing 71 fixed to the arm 68 and which can have a knurled head 72 arranged outside the casing 60 to rotate the screw 70 manually without tools. The casing 60 can also contain a connector 73, preferably a USB connector mounted on the printed circuit board 61 for connecting the weighing module 22 with the central unit 21. The weighing module 22 preferably comprises one or more sensors 74, 76 suitable for detecting movements of the suspended module mechanically connected to the weighing module 22. The sensors 74, 76 can comprise a piezoelectric sensor arranged on the arm 68 at the shaped bushing 71 and/or a magnetic sensor 76 mounted on an extension of the printed circuit board 61 arranged beside the arm 68. In alternative embodiments, the sensors 74, 76 can also be applied to the suspended module. The connector 73 is preferably protected by a removable cap 77 applied to the casing 60 when the connector 73 is not connected to a cable.

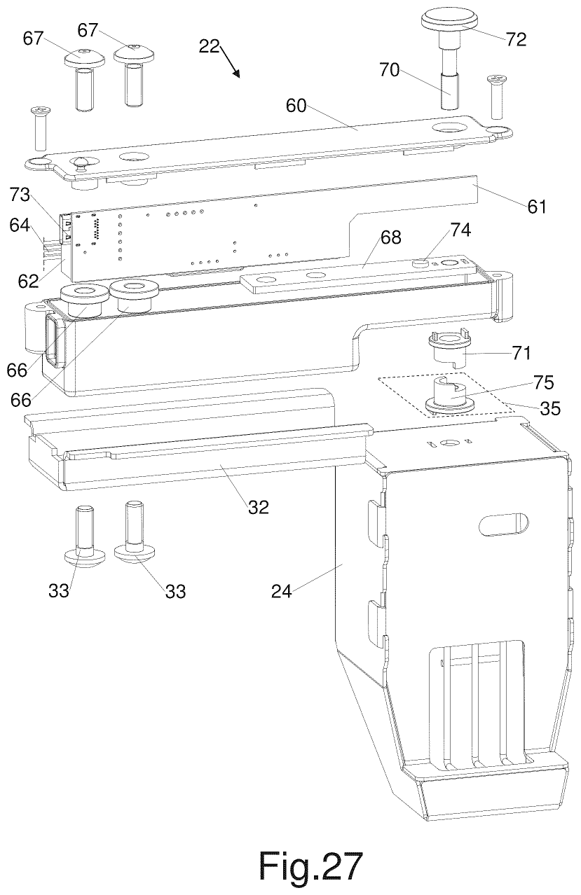

With reference also to FIG. 27, a suspended module, for example the feeder 24, comprises a second shaped bushing 75 which is threaded and has a shape complementary to that of the first shaped bushing 71 of the weighing module 22, so that the shaped bushings 71 and 75 cannot rotate with respect to each other when they are joined by the screw 70 of the arm 68 screwed into the second shaped bushing 75. In this way, the screw 70 can pass through the first shaped bushing 71 and a window 35 (shown with a dashed line) obtained in the plate 30 of the partition 23 to be screwed into the second shaped bushing 75 and stably fix the suspended module to the weighing module 22.

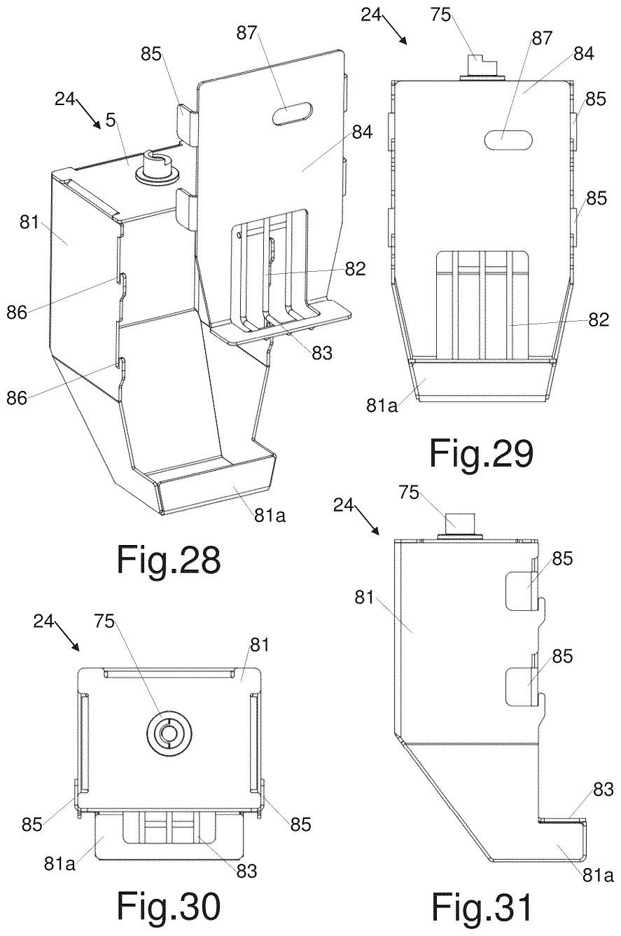

Referring also to FIGS. 28-31, the feeder 24 can comprise a container 81 suitable for containing food for animals, which is provided with a grid suitable for allowing a laboratory animal to eat the food contained in the container 81. This grid comprises a first portion 82 joined to a second portion 83, wherein these two portions 82, 83 form an angle between them greater than 60°, in particular 80-100°, so that a lower portion 81a of the container 81 protrudes from the rest of the container 81 and is arranged under the second portion 83 of the grid. In particular, the first portion 82 is vertical and the second portion 83 is horizontal. An upper wall of the container 81 is joined to the second shaped bushing 75. Preferably, the grid 82, 83 closes an opening formed in a cover 84 with an L-shaped profile, which is suitable in turn to close a corresponding opening formed in the container 81 for inserting the food. Preferably, the container 81 and/or the cover 84 are formed from a shaped and folded metal sheet. The cover 84 is provided with protuberances 85 suitable to be inserted into corresponding cavities 86 obtained along the edges of the opening of the container 81. The cover 84 can comprise an opening 87 which can cooperate with a tool to facilitate the removal of the cover 84 from the container 81.

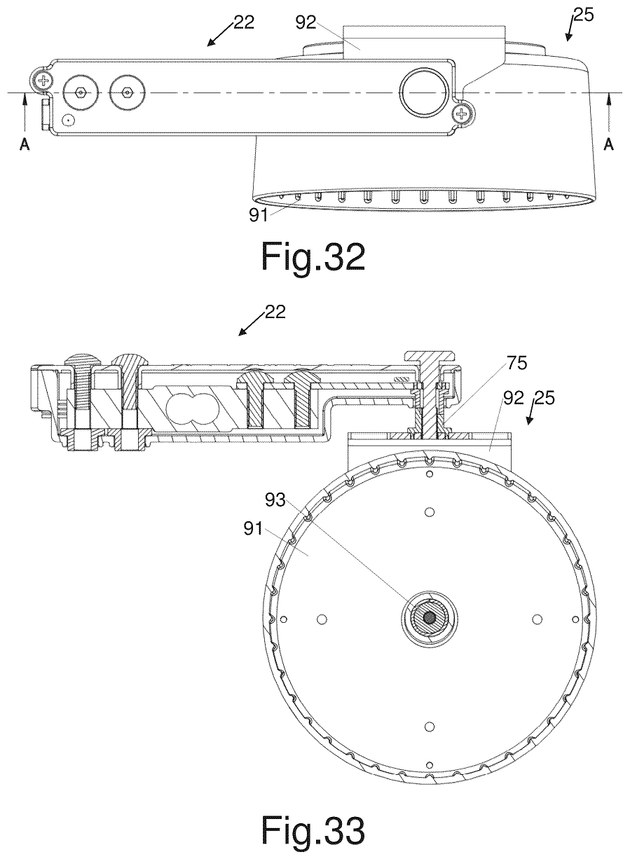

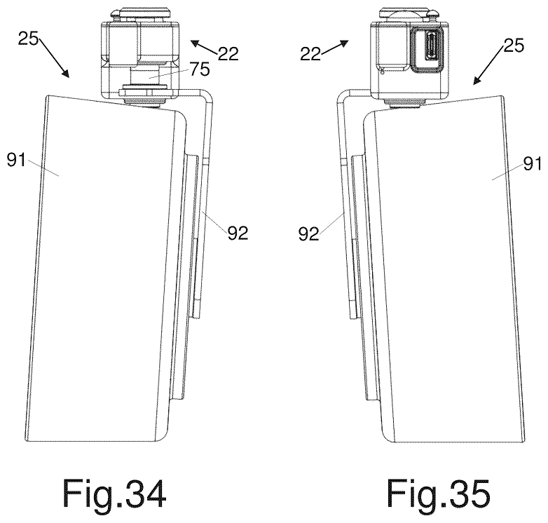

With reference also to FIGS. 32-35, the wheel 25 can comprise a rotating element 91 which can rotate with respect to a bracket 92 thanks to a bearing 93. Preferably, the rotating element 91 is substantially frustoconical shaped with the axis inclined by 0°-10° with respect to a horizontal plane. The second shaped bushing 75 of the wheel 25 is joined to an upper wall of the bracket 92.

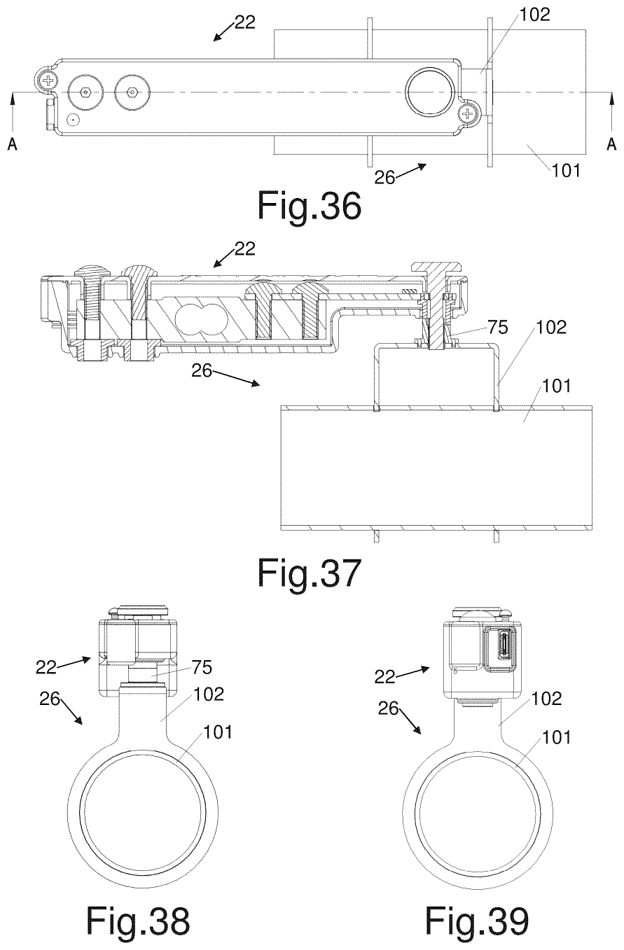

Referring also to FIGS. 36-39, a suspended module, in particular alternative to the wheel 25, can comprise a first shelter 26 for laboratory animals, which comprises a tubular body 101 suitable to house a laboratory animal. Preferably, the tubular body 101 is transparent and/or has a substantially cylindrical shape with the axis inclined by 0°-10° with respect to a horizontal plane. The tubular body 101 is joined to a bracket 102 having an upper wall provided with a second shaped bushing 75 for the mechanical connection of the shelter 26 with a weighing module 22.

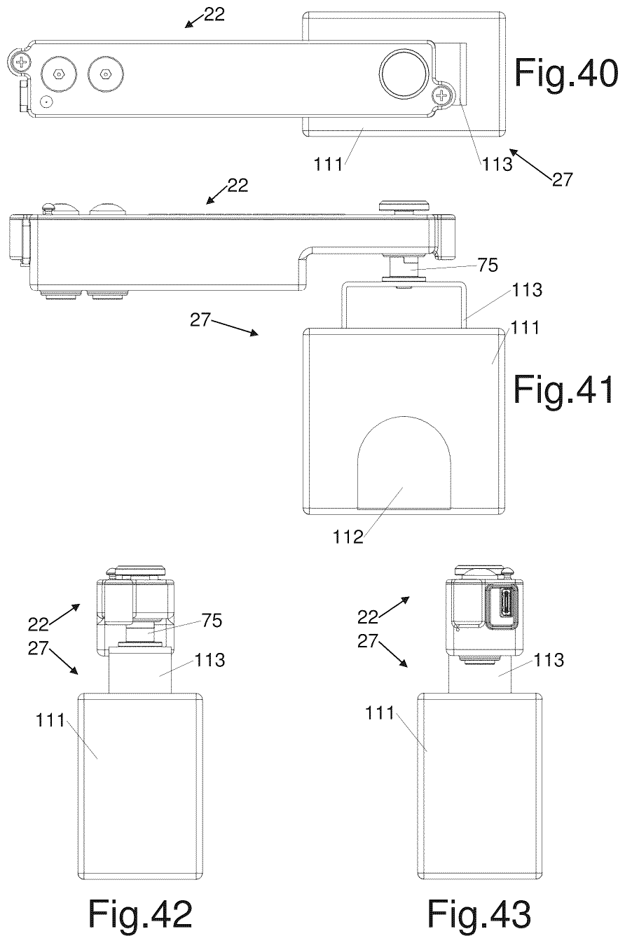

Referring also to FIGS. 40-43, a suspended module, in particular alternative to the wheel 25 or to the first shelter 26, can comprise a second shelter 27 for laboratory animals, which in turn comprises a box-shaped body 111 which is suitable to house a laboratory animal and is provided with a door 112. Preferably, the box-shaped body 111 has a substantially parallelepiped shape. The box-shaped body 111 is joined to a bracket 113 having an upper wall provided with a second shaped bushing 75 for the mechanical connection of the shelter 27 with a weighing module 22.

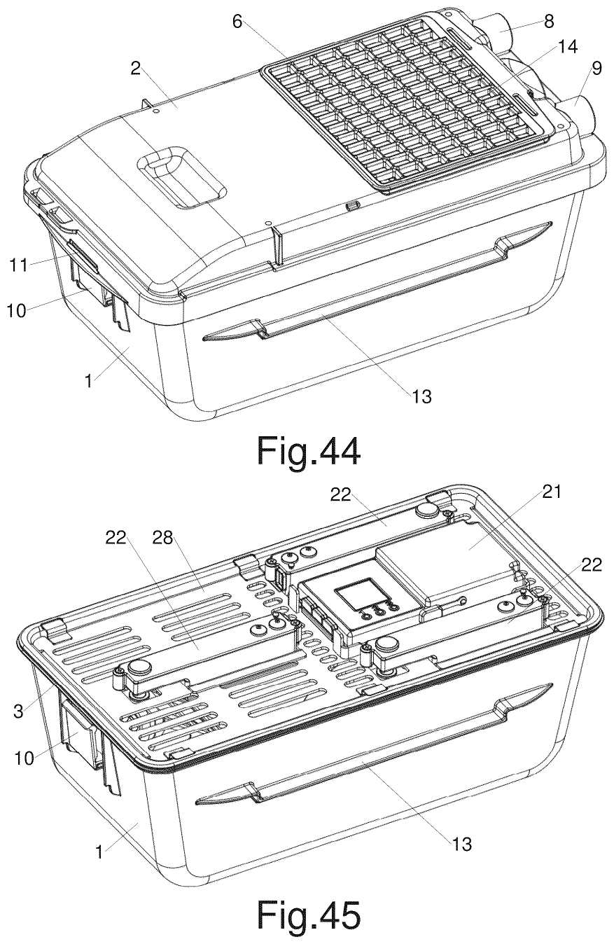

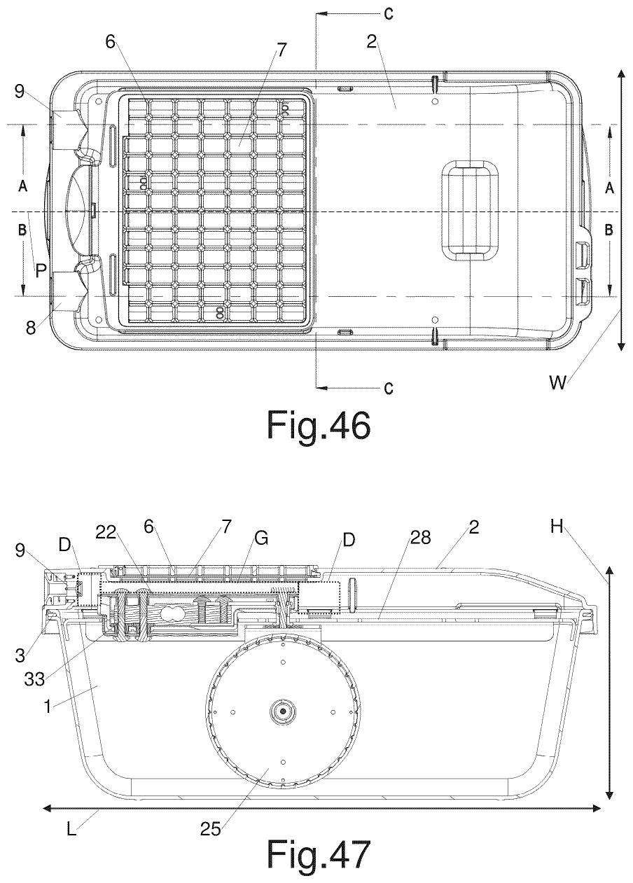

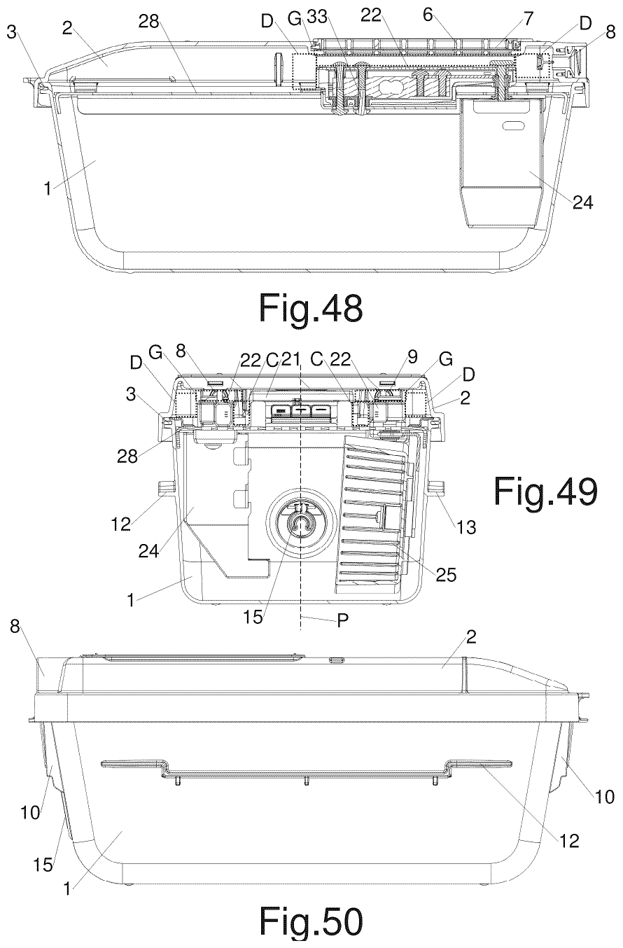

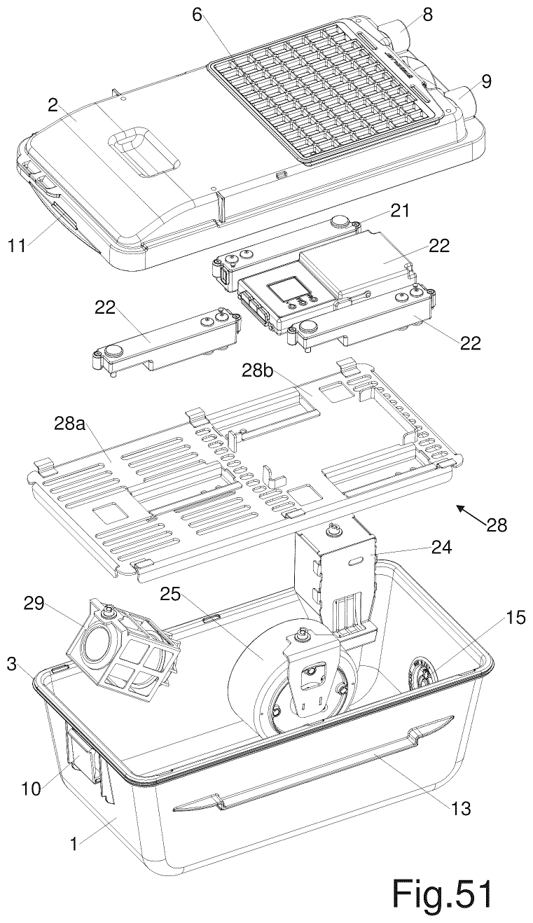

FIGS. 44-51 show a second embodiment of the laboratory cage, which is similar to the first embodiment, since it comprises a container 1 having an opening which can be closed by a lid 2. However, in this embodiment the weighing system comprises a central unit 21 and three weighing modules 22 applied to a partition 28 which can completely cover the opening of the container 1. In particular, the central unit 21 and two weighing modules 22 are arranged in seats 31, 32 obtained in a rear portion 28a of the partition 28 which is substantially the same as the partition 23 of the first embodiment, without the grid 38, while the third weighing module 22 is arranged in a seat 32 obtained in a front portion 28b of the partition 28 which is not present in the partition 23 and which extends to the front of the cage. The third weighing module 22 can be mechanically connected to a suspended module which comprises a drinker 29 suitable to contain liquids, for example water, for watering the animal in the cage. The lid 2 may therefore not be provided with a seat and a valve for a drinker arranged outside the cage.

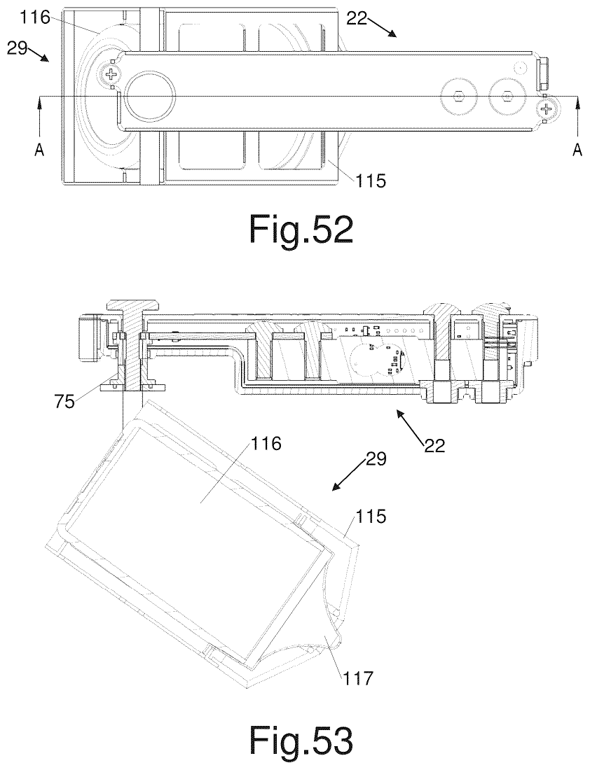

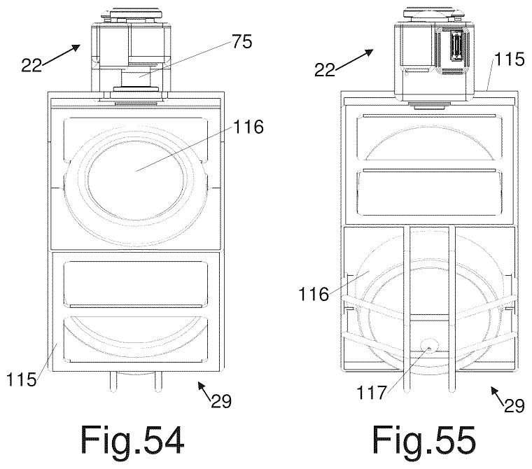

With reference also to FIGS. 52-55, the drinker 29 comprises a support structure 115 having an upper wall provided with a second shaped bushing 75 for the mechanical connection of the drinker 29 with a weighing module 22. The support structure 115 of the drinker 29 supports a bottle 116 which is preferably inclined by 30°-60° downwards and comprises a teat 117 facing a vertical plane passing through the center of the partition 28. The bottle 116 is removably inserted in support structure 115 so that it is possible to replace an empty bottle with a full one without removing the drinker 29 from the weighing module 22.

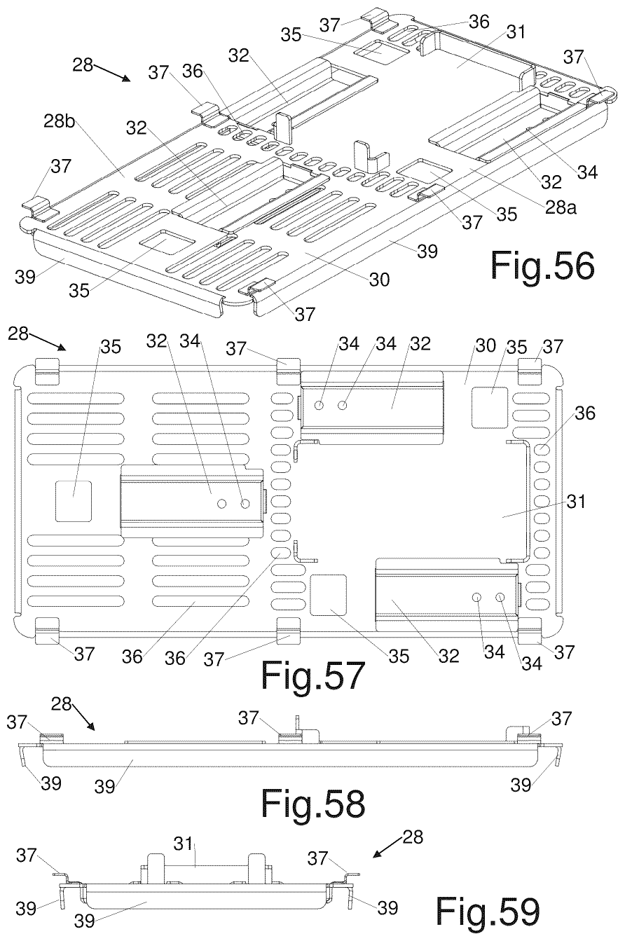

With reference also to FIGS. 56-59, the partition 28 is similar to the partition 23 of the first embodiment, since it comprises a plate 30 which is provided with one or more seats 31, 32 for partially or completely housing the central unit 21 and/or the weighing modules 22, as well as one or more windows 35 for the mechanical connection between a weighing module 22 and a suspended module, for example the feeder 24, the wheel 25, a shelter 26, 27 or the drinker 29. The seat 32 for the third weighing module 22 is arranged substantially in the center of the front portion 28b of the partition 28. The vents 36 in the rear portion 28a of the partition 28, namely the portion adjacent to the inlet duct 8 and the outlet duct 9, occupy an overall area smaller than the sum of the areas of the vents 36 in the front portion 28b of the partition 28.

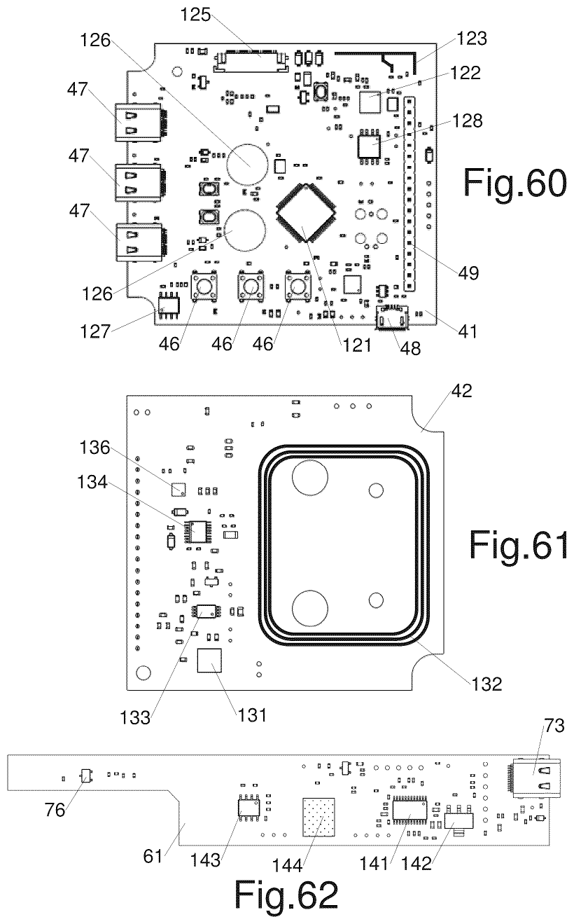

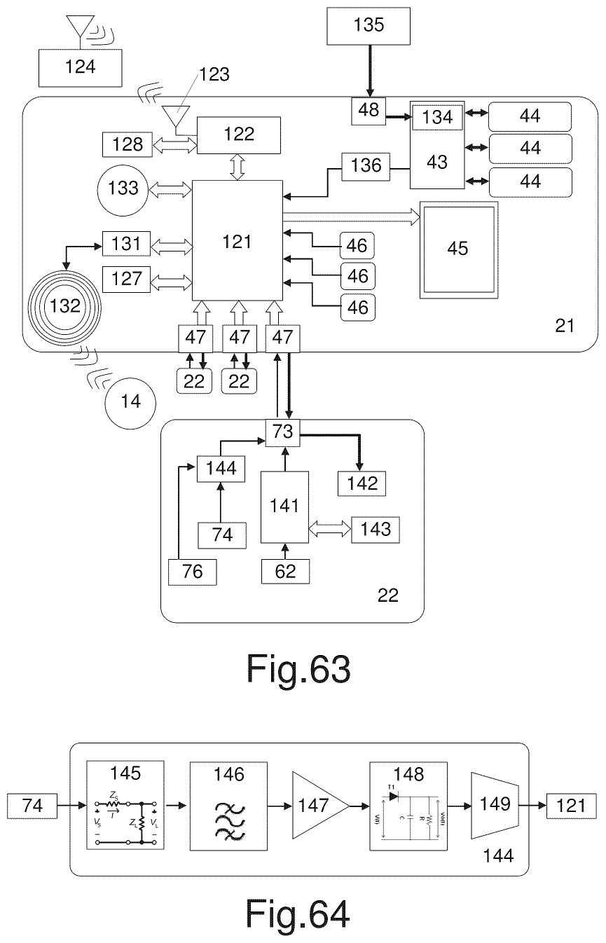

Referring also to FIGS. 60-63, the central unit 21 comprises a control device 121, in particular an ARM ultra-low-power microcontroller with real time clock (RTC) such as for example the STM32L431RCTx microcontroller, which is suitable to control the whole system. The control device 121 is connected to a transceiver 122, in particular a Wi-Fi module, more particularly a Wi-Fi microcontroller such as the ESP8266EX microcontroller, to transmit radio signals containing digital data, for example at a frequency of 2.4 GHz, via an antenna 123 to an external transceiver 124, in particular a Wi-Fi router placed near or on a shelf for laboratory cages. The control device 121 is connected via a cable (not shown in the figures) joined to a connector 125 to the display 45, which is arranged on the printed circuit board 41 via spacers 126, in particular having a substantially frustoconical shape. The control device 121 is connected to a non-volatile memory 127, in particular a FRAM memory (Ferroelectric Random Access Memory) such as for example the MB85RC1MT memory, for storing the data received from the control device 121. The transceiver 122 can be connected to a non-volatile memory 128, in particular a flash memory such as for example the W25Q64JVSSIMCT memory, for storing the parameters of the transceiver 122. The control device 121 is also connected to the input means 46 to receive commands or parameters from the operator, for example to turn the system on or off. The control device 121 is also connected to the connectors 47 for receiving data from the weighing modules 22 via one or more cables (not shown in the figures).

The input means 46, the connectors 47, 48 and/or 49, the control device 121, the transceiver 122, the antenna 123, the connector 125, the spacers 126 and/or the memories 127 and/or 128 are preferably arranged on the first printed circuit board 41 of the central unit 21.

The control device 121 is connected via the connector 49 to an RFID reader 131, in particular a multi-protocol transceiver such as the CR95HF transceiver, which is suitable to read the RFID tag 14 via an RFID antenna 132. Alternatively or additionally to the RFID tag 14 and/or the RFID reader 131, the central unit 21 can comprise its own RFID tag 133, in particular a programmable RFID transceiver such as for example the M24SR02-Y RFID transceiver, which is connected to the control device 121, so that the RFID tag 133 can be used to send, alternatively or in addition to an identification code, data or signals, such as for example parameters or alarms, from the control device 121 to an external RFID reader, in particular an RFID reader mounted on a shelf for laboratory cages. The power supply unit 43 can comprise a charger 134, in particular a PWM (Pulse Width Modulation) charger such as for example the LT1510 charger, which is connected to the connector 48 to charge the batteries 44 from an external source 135, for example a USB charger. The power supply unit 43 supplies the components of the central unit 21 and/or of the weighing modules 22. The control device 121 can be connected to the power supply unit 43 by means of a charge meter 136, in particular a multicell meter for measuring current, voltage and/or temperature such as the LTC2943 meter, suitable for measuring the charge levels of the batteries 44.

The RFID reader 131, the RFID antenna 132, the RFID tag 133, the charger 134 and/or the charge meter 136 are preferably arranged on the second printed circuit board 42 of the central unit 21.

The weighing module 22 can comprise an ADC 141, in particular a programmable analog-to-digital converter with temperature sensor such as the AD7124-4TRUZ-EP converter, which is suitable to receive the analog signal transmitted by the load cell 62, convert it into a digital signal and transmit it to the control device 121 through the connector 73. A stabilizer 142, in particular a voltage regulator equipped with filters, is connected to the connector 73 of the weighing module 22 to receive electrical energy from the power supply unit 43 of the central unit 21 and supply stabilized and filtered electrical energy to the components of the weighing module 22. The ADC 141 can be connected to a non-volatile memory 143, in particular a flash memory such as the M95040-WMN6TP memory, to store calibration, tare and/or compensation data of the load cell 62.

Referring also to FIG. 64, the sensors 74 and/or 76 are connected to a matching circuit 144 which includes an impedance matching 145, a filter 146, an amplifier 147, an envelope detector 148 and/or a threshold comparator 149 connected to each other, in particular with a series connection. The impedance matching 145 receives the output signal from the sensor 74 or 76 and maximizes the power transfer of the signal. The filter 146, preferably a 10-300 Hz bandpass filter, filters the output signal from the impedance matching 145 to filter signals of the accidental vibrations from the actual vibration signals of the suspended module, after which the output signal from the filter 146 is amplified by the amplifier 147, in particular with an operational amplifier, processed by the envelope detector 148 and/or compared with a threshold value by the threshold comparator 149, before the signal is transmitted from the adapter circuit 144 to the control device 121 of the central unit 21 through the connector 73 to activate the central unit 21.

The ADC 141, the stabilizer 142, the memory 143 and/or the components of the matching circuit 144 are preferably arranged on the printed circuit board 61 of the weighing module 22.

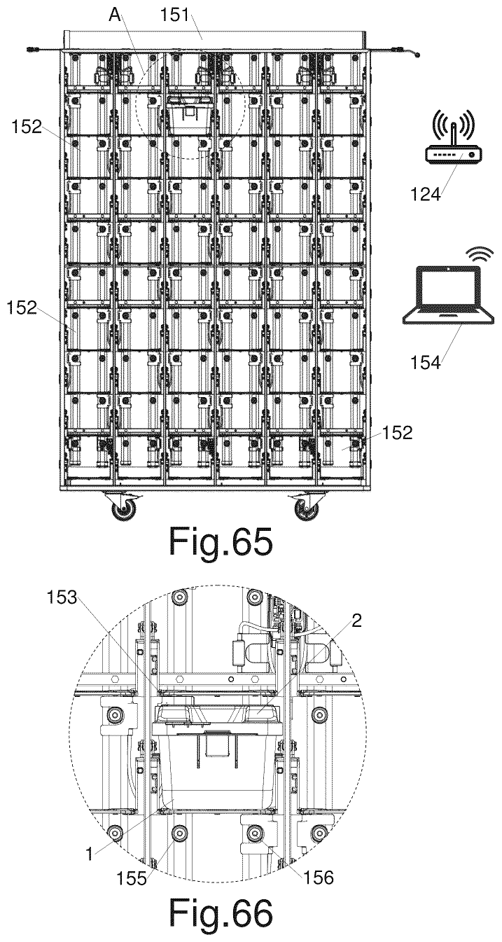

With reference also to FIGS. 65-66, a shelf 151 for laboratory cages comprises a plurality of stations 152 in which a laboratory cage can be placed, in particular the laboratory cage according to the present description. The stations 152 are provided with an RFID reader 153 arranged preferably above the position of the cage, so as to be suitable to read the RFID tag 14 arranged in the lid 2 of the cage and/or the RFID tag 133 arranged in the central unit 21. A computer 154 of an operator can receive through the Wi-Fi router 124 the data transmitted by the central unit 21 of the weighing system applied to the laboratory cage. The height of the stations 152 is preferably 16-20 cm, so that up to ten cages according to the present description can be arranged one above the other in the rack 151 and be picked up manually by the operator without using ladders or steps. The stations 152 are provided with an outlet duct 155 and an inlet duct 156 which can be connected respectively to the inlet duct 8 and to the outlet duct 9 for the ventilation of the cage.

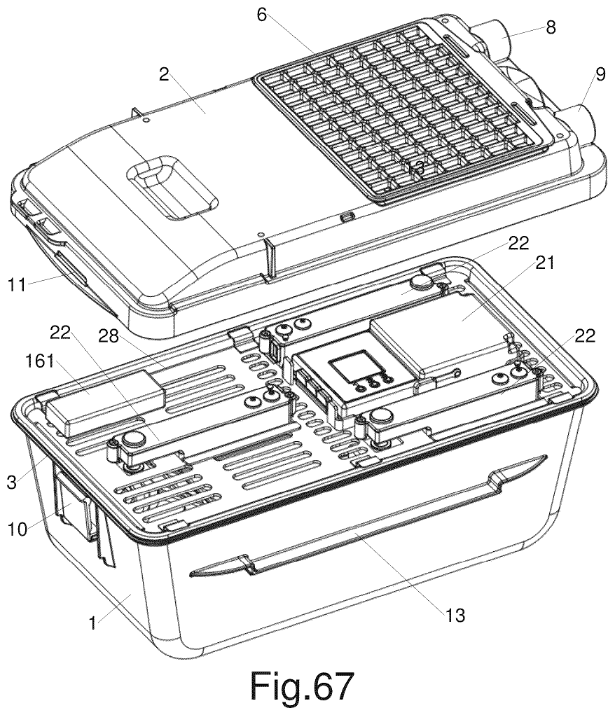

FIG. 67 shows a third embodiment of the laboratory cage, which is similar to the second embodiment but comprises one or more antennas 161, preferably suitable for operating in “diversity” mode, which are arranged outside the central unit 21, in particular on the front portion 28b of the partition 28, and are connected with coaxial cables (not shown in the figure) to the transceiver 122 of the central unit 21, in addition or alternatively to the antenna 123 in the central unit 21.

A fourth embodiment of the laboratory cage, not shown in the figures, is similar to one of the first three embodiments but includes an antenna formed by the partition 23 or 28, which is made of metal and is connected by a cable to the transceiver 122 of the central unit 21, in addition or as an alternative to the antenna 123 in the central unit 21 and/or to the antennas 161 arranged outside the central unit 21.

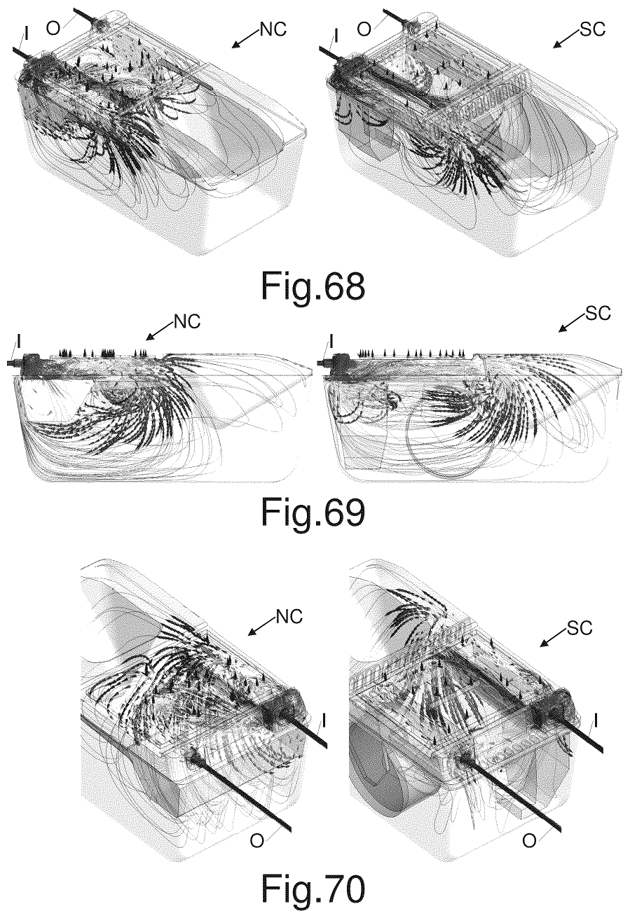

FIGS. 68-70 show, on the left side, the air flow lines in a known cage NC and, on the right side, in the cage SC which comprises the first embodiment of the system and has substantially the same shape and the same dimensions of the known cage NC. The cages NC and SC are connected to ventilation ducts, for example those of the shelf 151, which introduce incoming air I and withdraw outgoing air O substantially with the same flow rate. The results of these fluid dynamics simulations show that the flow lines in the cages NC and SC are substantially the same, despite the fact that the cage SC with the system also has the wheel 25 which is not present in the known cage NC.

In use, in a preliminary procedure of the method according to the present description, an operator prepares the weighing system by applying in a first step the central unit 21 and the weighing modules 22 to the partition 23 or 28 and fixing the suspended modules 24, 25, 26, 27 and/or 29 to the weighing modules 22, after which he places the partition 23 or 28 in the cage, in particular on the container 1. The drinker 29, if present, and the feeder 24 respectively contain liquids and food for the animal in the cage. Once applied to the cage, the system can then be turned on and initialized by the operator by interacting with the input means 46 and the output means 45. During initialization of the system, the weighing modules 22 are calibrated by the control device 121 resetting the values obtained from the load cells 62, so as to memorize the initial weight of the suspended modules 24, 25, 26, 27 and/or 29. The animal is inserted into the cage before applying the partition 28, or even after if the partition 23 does not close the container 1. The central unit 21 can be applied to the partition 23 or 28 even after the partition 23 or 28 is placed above the container 1 with the weighing modules 22.

Before closing the cage with the lid 2, the operator activates the central unit 21 with the input means 46, so that the central unit 21 reads the first RFID tag that is brought near to it, in particular the RFID tag 14 in the lid 2. When the cage is closed by the lid 2, the central unit 21 reads the identification code of the RFID tag 14 and stores it in the memory 127, after which it deactivates the RFID reader 131 to save energy. If the central unit 21 includes the RFID tag 133, the operator, before closing the lid 2, reads the identification code of the RFID tag 133 with an RFID reader, in particular connected to the processor 154, so as to associate the cage or central unit 21 to this identification code.

The operator then closes the cage with the lid 2 and inserts it in a station 152 of the shelf 151. When the cage is inserted in the shelf 151, the RFID reader 153 of the station 152 reads the identification code of the RFID tag 14 or of the RFID tag 133 and sends it to the processor 154, which associates the cage with this identification code, so that signals containing weighing data and the same identification code are associated with the same cage by the processor 154.

In a weighing procedure of the method according to the present description, the control device 121 of the central unit 21 performs a weighing step in which it reads the weighing data from the load cells 62 of the weighing modules 22 and stores this data in the memory 127, preferably associating them to the current time t, after which it goes into stand-by for a given time t1, for example one hour. At the end of the time t1, the control device 121 wakes up and carries out a new weighing phase. If one of the sensors 74, 76 detects a movement of a suspended module when the control device 121 is in stand-by, the control device 121 is reactivated by this sensor and performs an additional weighing phase, after which it goes into stand-by. After one or more weighing phases, in particular after a time t2, for example one day, the control device 121 wakes up and transmits the weighing data in the memory 127 through the transceiver 122, after which it erases the memory 127 and goes into stand-by.

Variations or additions can be made by those skilled in the art to the embodiments described and illustrated herein while remaining within the scope of the following claims. In particular, further embodiments can comprise the technical characteristics of one of the following claims with the addition of one or more technical characteristics described in the text or illustrated in the drawings, taken individually or in any reciprocal combination and including their equivalent characteristics.

Furthermore, the terms “one/one/one”, “two”, etc. in the description and in the claims they mean respectively “at least one/one/one”, “at least two”, etc., unless otherwise specified. Similarly, angles, proportions and values mentioned in the text and/or shown in the drawings include a tolerance of at least 5%, again unless otherwise specified

1-39. (canceled)

40. A weighing system suitable to be applied to a laboratory cage comprising a container having an opening which can be closed by a lid, wherein the weighing system comprises a central unit and one or more weighing modules mechanically connected to a suspended module which is suitable to support or contain a mass to be weighed in the laboratory cage, wherein the central unit and the weighing modules are applied to a partition suitable to be arranged with the central unit and the weighing modules inside the laboratory cage with the container closed by the lid, wherein the partition divides the central unit and each weighing module from the suspended module mechanically connected to this weighing module.

41. The weighing system according to claim 40, wherein the central unit and/or the weighing modules have an elongated shape which develops along a longitudinal axis parallel to the median plane of the partition.

42. The weighing system according to claim 40, wherein the central unit and the weighing modules are separated from each other and arranged on the partition side by side, so that the space between the central unit and a weighing module forms a channel which develops along a longitudinal axis parallel to the median plane of the partition.

43. The weighing system according to claim 40, which is arranged in a laboratory cage closed by a lid provided with an upper wall, an inlet duct and/or an outlet duct for the ventilation of the laboratory cage, wherein the central unit and/or the weighing modules are spaced from the inner surface of the upper wall of the lid, so that the inlet duct and/or the outlet duct of the lid open into one or more gaps between the lid and the central unit and/or the weighing modules.

44. The weighing system according to claim 40, wherein the central unit and/or the weighing modules are spaced from the edges of the partition, so as to form around the central unit and/or the weighing modules one or more passages for air circulation.

45. The weighing system according to claim 42, wherein the channels are connected to each other so as to form air paths on the partition around the central unit and/or the weighing modules.

46. The weighing system according to claim 43, wherein the gaps are connected to each other so as to form air paths on the partition around the central unit and/or the weighing modules.

47. The weighing system according to claim 44, wherein the passages are connected to each other so as to form air paths on the partition around the central unit and/or the weighing modules.

48. The weighing system according to claim 40, wherein the partition comprises one or more seats for housing partially or completely the central unit and/or the weighing modules, as well as one or more windows for the mechanical connection between a weighing module and a suspended module.

49. The weighing system according to claim 40, wherein the partition comprises vents arranged one after the other along one or more axes parallel and/or perpendicular to the median plane of the partition.

50. The weighing system according to claim 48, wherein the partition comprises vents arranged one after the other along one or more axes parallel and/or perpendicular to the median plane of the partition.

51. The weighing system according to claim 50, wherein the vents are arranged beside the seats for the central unit and/or for the weighing modules, so that the vents open onto one or more channels and/or passages arranged around the central unit and/or the weighing modules.

52. The weighing system according to claim 40, wherein the partition comprises one or more lateral supports which protrude from the edges of the partition to rest the partition on one or more edges of the container of the laboratory cage, so that the partition partially or completely covers the opening of the container and is blocked by the lid when the laboratory cage is closed by the lid.

53. The weighing system according to claim 40, wherein the central unit comprises a casing which contains one or more printed circuit boards on which electrical and electronic components are mounted for processing weighing data transmitted by the weighing modules, as well as a power supply unit, output means, input means and/or one or more connectors for the electrical connection via cables of the central unit with the weighing modules and/or with external devices for power supply or data transmission.

54. A laboratory cage comprising a container having an opening which is closed by a lid, wherein a weighing system according to claim 1 is arranged in the laboratory cage under the lid, and wherein the central unit and the weighing module(s) are arranged between the partition of the weighing system and the lid.

55. The laboratory cage according to claim 54, wherein the central unit and the weighing modules are arranged in a portion of the space delimited by the container and in a portion of the space delimited by the lid.

56. A weighing method for weighing one or more suspended modules that are suitable to support or contain a mass to be weighed in a laboratory cage comprising a container having an opening that can be closed by a lid, comprising the following operating steps:
one or more weighing modules are applied to a partition suitable to be arranged with the weighing modules inside a laboratory cage;
each suspended module is mechanically connected to a weighing module;
the partition is placed in the laboratory cage;
a central unit is applied to the partition and electrically connected to the weighing modules before or after the partition is placed in the laboratory cage, wherein the partition divides the central unit and each weighing module from the suspended module mechanically connected to this weighing module;
the container of the laboratory cage is closed with the lid;
the central unit and said one or more weighing modules carry out one or more weighing steps in which the weighing modules transmit weighing data of the suspended modules to the central unit.

57. The weighing method according to claim 56, wherein the central unit and/or the weighing modules have an elongated shape which develops along a longitudinal axis parallel to the median plane of the partition.

58. The weighing method according to claim 56, wherein the central unit and the weighing modules are separated from each other and arranged on the partition side by side, so that the space between the central unit and a weighing module forms a channel which develops along a longitudinal axis parallel to the median plane of the partition.

59. The weighing method according to claim 56, wherein the partition comprises one or more seats for housing partially or completely the central unit and/or the weighing modules, as well as one or more windows for the mechanical connection between a weighing module and a suspended module.
